(19) United States
(12) Patent Application Publication
(10) Pub. No.: US 2009/0125703 A1
(43) Pub. Date: May 14, 2009

(54) Context Switching on a Network On Chip

(76) Inventors: Eric O. Mejdrich, Rochester, MN (US); Paul E. Schardt, Rochester, MN (US); Robert A. Shearer, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/937,579

(22) Filed: Nov. 9, 2007

(51) Int. Cl. G06F 15/76; G06F 9/30

(52) U.S. Cl. 712/30; 712/E09.016

(57) ABSTRACT

Data processing on a network on chip (‘NOC’) that includes integrated processor (‘IP’) blocks, routers, memory communications controllers, and network interface controllers, with each IP block adapted to a router through a memory communications controller and a network interface controller, with each IP block also adapted to the network by a low latency, high bandwidth application messaging interconnect comprising an inbox and an outbox, each IP block also including a stack normally used for context switching, the stack access slower than the outbox access, and each IP block further including a processor supporting a plurality of threads of execution, the processor configured to save, upon a context switch, a context of a current thread of execution in memory locations in a memory array in the outbox instead of the stack and lock the memory locations in which the context was saved.

### BACKGROUND OF THE INVENTION

1. Field of the Invention

The field of the invention is data processing, or, more specifically apparatus and methods for data processing with a network on chip (‘NOC’).

2. Description of Related Art

There are two widely used paradigms of data processing; multiple instructions, multiple data (‘MIMD’) and single instruction, multiple data (‘SIMD’). In MIMD processing, a computer program is typically characterized as one or more threads of execution operating more or less independently, each requiring fast random access to large quantities of shared memory. MIMD is a data processing paradigm optimized for the particular classes of programs that fit it, including, for example, word processors, spreadsheets, database managers, many forms of telecommunications such as browsers, for example, and so on.

SIMD is characterized by a single program running simultaneously in parallel on many processors, each instance of the program operating in the same way but on separate items of data. SIMD is a data processing paradigm that is optimized for the particular classes of applications that fit it, including, for example, many forms of digital signal processing, vector processing, and so on.

There is another class of applications, however, including many real-world simulation programs, for example, for which neither pure SIMD nor pure MIMD data processing is optimized. That class of applications includes applications that benefit from parallel processing and also require fast random access to shared memory. For that class of programs, a pure MIMD system will not provide a high degree of parallelism and a pure SIMD system will not provide fast random access to main memory stores.

### SUMMARY OF THE INVENTION

Methods and apparatus for data processing on a network on chip (‘NOC’) that includes integrated processor (‘IP’) blocks, routers, memory communications controllers, and network interface controllers, with each IP block adapted to a router through a memory communications controller and a network interface controller, where each memory communications controller controlling communications between an IP block and memory, each network interface controller controlling inter-IP block communications through routers, with each IP block also adapted to the network by a low latency, high bandwidth application messaging interconnect comprising an inbox and an outbox, each IP block also including a stack normally used for context switching, the stack access slower than the outbox access, and each IP block further including a processor supporting a plurality of threads of execution, the processor configured to save, upon a context switch, a context of a current thread of execution in memory locations in a memory array in the outbox instead of the stack and lock the memory locations in which the context was saved.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in data processing with a NOC according to embodiments of the present invention.

FIG. 2 sets forth a functional block diagram of an example NOC according to embodiments of the present invention.

FIG. 3 sets forth a functional block diagram of a further example NOC according to embodiments of the present invention.

FIG. 4 sets forth a functional block diagram of a further example NOC according to embodiments of the present invention.

FIG. 5 sets forth an exemplary timing diagram that illustrates pipeline operations in a processor of an IP block on a NOC according to embodiments of the present invention.

FIG. 6 sets forth a functional block diagram of exemplary apparatus for data processing on a NOC according to embodiments of the present invention.

FIG. 7 sets forth a flow chart illustrating an exemplary method for data processing with a NOC according to embodiments of the present invention.

FIG. 8 sets forth a flow chart illustrating a further exemplary method for data processing with a NOC according to embodiments of the present invention.

FIG. 9 sets forth a flow chart illustrating a further exemplary method for data processing with a NOC according to embodiments of the present invention.

### DETAILED DESCRIPTION OF EXEMPLARY EMBODIMENTS

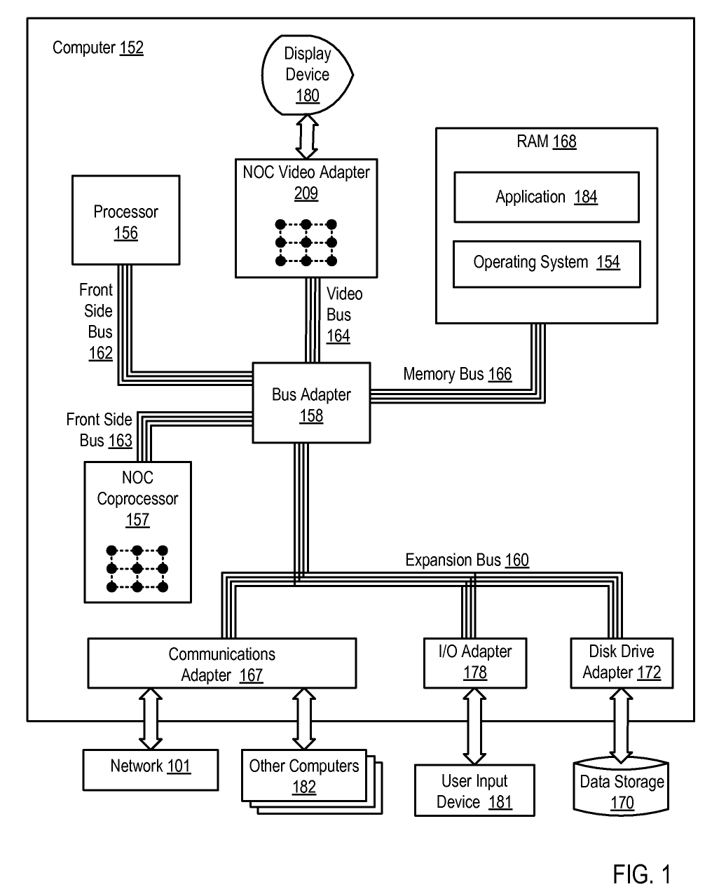

Exemplary apparatus and methods for data processing with a NOC in accordance with the present invention are described with reference to the accompanying drawings, beginning with FIG. 1. FIG. 1 sets forth a block diagram of automated computing machinery comprising an exemplary computer (152) useful in data processing with a NOC according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an application program (184), a module of user-level computer program instructions for carrying out particular data processing tasks such as, for example, word processing, spreadsheets, database operations, video gaming, stock market simulations, atomic quantum process simulations, or other user-level applications. Also stored in RAM (168) is an operating system (154). Operating systems useful data processing with a NOC according to embodiments of the present invention include UNIX™, Linux™, Microsoft XP™, AIX™, IBM's i5/OS™, and others as will occur to those of skill in the art. The operating system (154) and the application (184) in the example of FIG. 1 are shown in RAM (168), but many components of such software typically are stored in non-volatile memory also, such as, for example, on a disk drive (170).

The example computer (152) includes two example NOCs according to embodiments of the present invention: a video adapter (209) and a coprocessor (157). The video adapter (209) is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example NOC coprocessor (157) is connected to processor (156) through bus adapter (158), and front side buses (162 and 163), which is also a high speed bus. The NOC coprocessor of FIG. 1 is optimized to accelerate particular data processing tasks at the behest of the main processor (156).

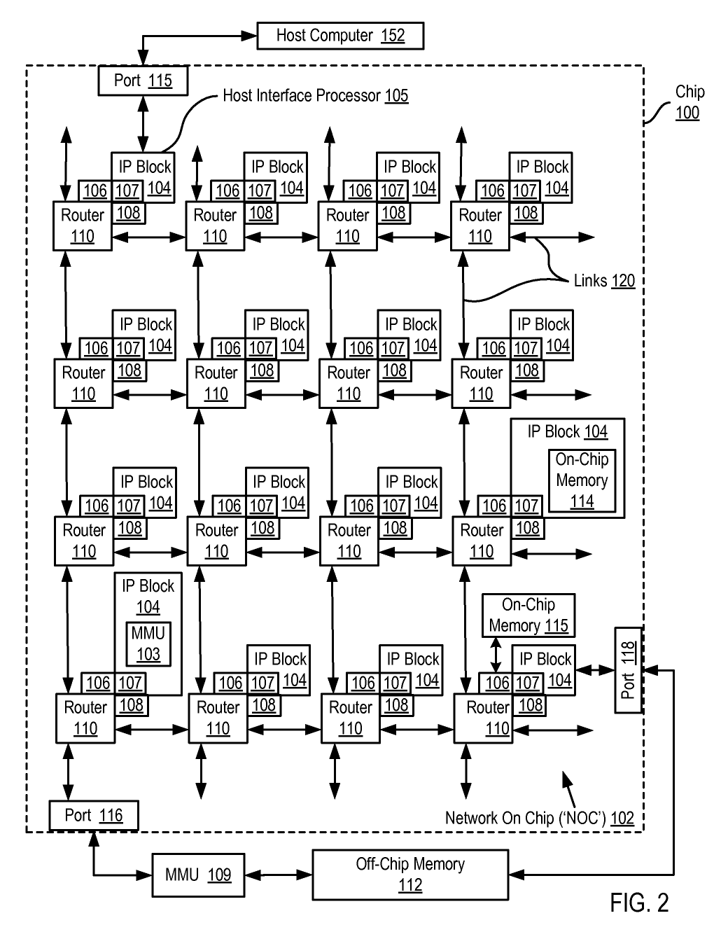

The example NOC video adapter (209) and NOC coprocessor (157) of FIG. 1 each include a NOC according to embodiments of the present invention, including integrated processor (‘IP’) blocks, routers, memory communications controllers, and network interface controllers, each IP block adapted to a router through a memory communications controller and a network interface controller, each memory communications controller controlling communication between an IP block and memory, and each network interface controller controlling inter-IP block communications through routers. Each IP block is also adapted to the network by a low latency, high bandwidth application messaging interconnect comprising an inbox and an outbox. In addition, each IP block also includes a stack normally used for context switching, where the stack access is slower than the outbox access. Each IP block also includes a processor supporting a plurality of threads of execution, where the processor is configured to save, upon a context switch, a context of a current thread of execution in memory locations in a memory array in the outbox instead of the stack and lock the memory locations in which the context was saved. The NOC video adapter and the NOC coprocessor are optimized for programs that use parallel processing and also require fast random access to shared memory. The details of the NOC structure and operation are discussed below with reference to FIGS. 2-6.

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for data processing with a NOC according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for data processing with a NOC according to embodiments of the present invention include modems for wired dial-up communications, Ethernet (IEEE 802.3) adapters for wired data communications network communications, and 802.11 adapters for wireless data communications network communications.

FIG. 2

For further explanation, FIG. 2 sets forth a functional block diagram of an example NOC (102) according to embodiments of the present invention. The NOC in the example of FIG. 2 is implemented on a ‘chip’ (100), that is, on an integrated circuit.

The NOC (102) of FIG. 2 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the NOC (102) of FIG. 2, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs.

One way to describe IP blocks by analogy is that IP blocks are for NOC design what a library is for computer programming or a discrete integrated circuit component is for printed circuit board design. In NOCs according to embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well.

In the example of FIG. 2, each IP block includes a low latency, high bandwidth application messaging interconnect (107) that adapts the IP block to the network for purposes of data communications among IP blocks. As described in more detail below, each such messaging interconnect includes an inbox and an outbox. In addition, each IP block also includes a stack normally used for context switching, where the stack access is slower than the outbox access. Each IP block also includes a processor supporting a plurality of threads of execution, where the processor is configured to save, upon a context switch, a context of a current thread of execution in memory locations in a memory array in the outbox instead of the stack and lock the memory locations in which the context was saved.

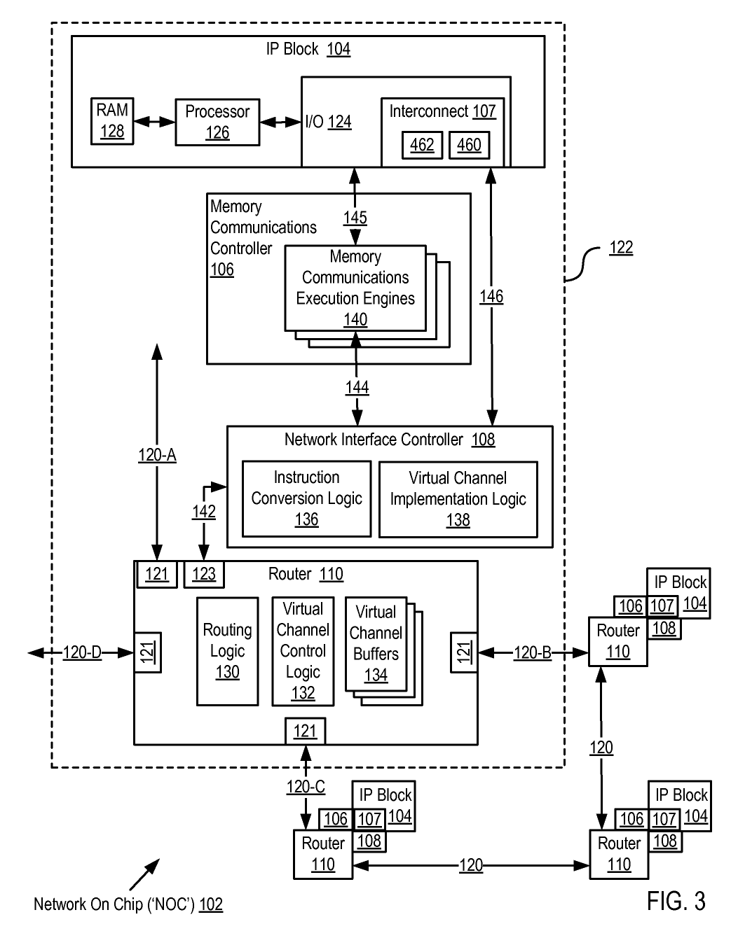

Each IP block (104) in the example of FIG. 2 is adapted to a router (110) through a memory communications controller (106). Each memory communication controller is an aggregation of synchronous and asynchronous logic circuitry adapted to provide data communications between an IP block and memory. Examples of such communications between IP blocks and memory include memory load instructions and memory store instructions. The memory communications controllers (106) are described in more detail below with reference to FIG. 3.

Each IP block (104) in the example of FIG. 2 is also adapted to a router (110) through a network interface controller (108). Each network interface controller (108) controls communications through routers (110) between IP blocks (104). Examples of communications between IP blocks include messages carrying data and instructions for processing the data among IP blocks in parallel applications and in pipelined applications. The network interface controllers (108) are described in more detail below with reference to FIG. 3.

Each IP block (104) in the example of FIG. 2 is adapted to a router (110). The routers (110) and links (120) among the routers implement the network operations of the NOC. The links (120) are packets structures implemented on physical, parallel wire buses connecting all the routers. That is, each link is implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wise, 512 wires. In addition, each link is bi-directional, so that if the link packet structure includes 64 bytes, the wire bus actually contains 1024 wires between each router and each of its neighbors in the network. A message can includes more than one packet, but each packet fits precisely onto the width of the wire bus. If the connection between the router and each section of wire bus is referred to as a port, then each router includes five ports, one for each of four directions of data transmission on the network and a fifth port for adapting the router to a particular IP block through a memory communications controller and a network interface controller.

Each memory communications controller (106) in the example of FIG. 2 controls communications between an IP block and memory. Memory can include off-chip main RAM (112), memory (115) connected directly to an IP block through a memory communications controller (106), on-chip memory enabled as an IP block (114), and on-chip caches. In the NOC of FIG. 2, either of the on-chip memories (114, 115), for example, may be implemented as on-chip cache memory. All these forms of memory can be disposed in the same address space, physical addresses or virtual addresses, true even for the memory attached directly to an IP block. Memory-addressed messages therefore can be entirely bidirectional with respect to IP blocks, because such memory can be addressed directly from any IP block anywhere on the network. Memory (114) on an IP block can be addressed from that IP block or from any other IP block in the NOC. Memory (115) attached directly to a memory communication controller can be addressed by the IP block that is adapted to the network by that memory communication controller—and can also be addressed from any other IP block anywhere in the NOC.

The example NOC includes two memory management units (‘MMUs’) (103, 109), illustrating two alternative memory architectures for NOCs according to embodiments of the present invention. MMU (103) is implemented with an IP block, allowing a processor within the IP block to operate in virtual memory while allowing the entire remaining architecture of the NOC to operate in a physical memory address space. The MMU (109) is implemented off-chip, connected to the NOC through a data communications port (116). The port (116) includes the pins and other interconnections required to conduct signals between the NOC and the MMU, as well as sufficient intelligence to convert message packets from the NOC packet format to the bus format required by the external MMU (109). The external location of the MMU means that all processors in all IP blocks of the NOC can operate in virtual memory address space, with all conversions to physical addresses of the off-chip memory handled by the off-chip MMU (109).

In addition to the two memory architectures illustrated by use of the MMUs (103, 109), data communications port (118) illustrates a third memory architecture useful in NOCs according to embodiments of the present invention. Port (118) provides a direct connection between an IP block (104) of the NOC (102) and off-chip memory (112). With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port (118). The port (118) includes the pins and other interconnections required to conduct signals between the NOC and the off-chip memory (112), as well as sufficient intelligence to convert message packets from the NOC packet format to the bus format required by the off-chip memory (112).

In the example of FIG. 2, one of the IP blocks is designated a host interface processor (105). A host interface processor (105) provides an interface between the NOC and a host computer (152) in which the NOC may be installed and also provides data processing services to the other IP blocks on the NOC, including, for example, receiving and dispatching among the IP blocks of the NOC data processing requests from the host computer. A NOC may, for example, implement a video graphics adapter (209) or a coprocessor (157) on a larger computer (152) as described above with reference to FIG. 1. In the example of FIG. 2, the host interface processor (105) is connected to the larger host computer through a data communications port (115). The port (115) includes the pins and other interconnections required to conduct signals between the NOC and the host computer, as well as sufficient intelligence to convert message packets from the NOC to the bus format required by the host computer (152). In the example of the NOC coprocessor in the computer of FIG. 1, such a port would provide data communications format translation between the link structure of the NOC coprocessor (157) and the protocol required for the front side bus (163) between the NOC coprocessor (157) and the bus adapter (158).

FIG. 3

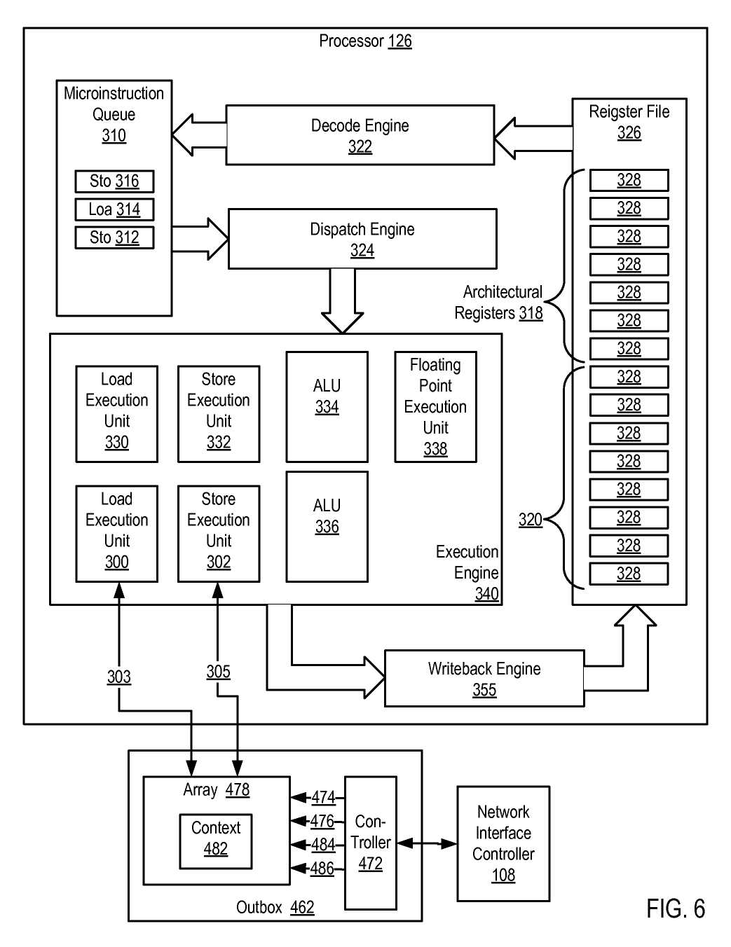

For further explanation, FIG. 3 sets forth a functional block diagram of a further example NOC according to embodiments of the present invention. The example NOC of FIG. 3 is similar to the example NOC of FIG. 6 in that the example NOC of FIG. 3 is implemented on a chip (100 on FIG. 6), and the NOC (102) of FIG. 3 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110). In the example of FIG. 3, one set (122) of an IP block (104) adapted to a router (110) through a memory communications controller (106) and network interface controller (108) is expanded to aid a more detailed explanation of their structure and operations. All the IP blocks, memory communications controllers, network interface controllers, and routers in the example of FIG. 3 are configured in the same manner as the expanded set (122).

In the example of FIG. 3, each IP block (104) includes a computer processor (126) and I/O functionality (124). In this example, computer memory is represented by a segment of random access memory (‘RAM’) (128) in each IP block (104). The memory, as described above with reference to the example of FIG. 6, can occupy segments of a physical address space whose contents on each IP block are addressable and accessible from any IP block in the NOC. The processors (126), I/O capabilities (124), and memory (128) on each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

In the example of FIG. 3, each IP block includes a low latency, high bandwidth application messaging interconnect (107) that adapts the IP block to the network for purposes of data communications among IP blocks. As described in more detail below, each such messaging interconnect includes an inbox (460) and an outbox (462). In addition, each IP block (104) also includes a stack normally used for context switching, where the stack access is slower than the outbox access. Each IP block also includes a processor (104) supporting a plurality of threads of execution, where the processor is configured to save, upon a context switch, a context of a current thread of execution in memory locations in a memory array in the outbox instead of the stack and lock the memory locations in which the context was saved.

In the NOC (102) of FIG. 3, each memory communications controller (106) includes a plurality of memory communications execution engines (140). Each memory communications execution engine (140) is enabled to execute memory communications instructions from an IP block (104), including bidirectional memory communications instruction flow (142, 144, 145) between the network and the IP block (104). The memory communications instructions executed by the memory communications controller may originate, not only from the IP block adapted to a router through a particular memory communications controller, but also from any IP block (104) anywhere in the NOC (102). That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine (140) is enabled to execute a complete memory communications instruction separately and in parallel with other memory communications execution engines. The memory communications execution engines implement a scalable memory transaction processor optimized for concurrent throughput of memory communications instructions. The memory communications controller (106) supports multiple memory communications execution engines (140) all of which run concurrently for simultaneous execution of multiple memory communications instructions. A new memory communications instruction is allocated by the memory communications controller (106) to a memory communications engine (140) and the memory communications execution engines (140) can accept multiple response events simultaneously. In this example, all of the memory communications execution engines (140) are identical. Scaling the number of memory communications instructions that can be handled simultaneously by a memory communications controller (106), therefore, is implemented by scaling the number of memory communications execution engines (140).

In the NOC (102) of FIG. 3, each network interface controller (108) is enabled to convert communications instructions from command format to network packet format for transmission among the IP blocks (104) through routers (110). The communications instructions are formulated in command format by the IP block (104) or by the memory communications controller (106) and provided to the network interface controller (108) in command format. The command format is a native format that conforms to architectural register files of the IP block (104) and the memory communications controller (106). The network packet format is the format required for transmission through routers (110) of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In the NOC (102) of FIG. 3, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. All memory-address-based communication that are executed with message traffic are passed from the memory communications controller to an associated network interface controller for conversion (136) from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communication controller (106) is naturally also the network location of that memory communication controller's associated router (110), network interface controller (108), and IP block (104). The instruction conversion logic (136) within each network interface controller is capable of converting memory addresses to network addresses for purposes of transmitting memory-address-based communications through routers of a NOC.

Upon receiving message traffic from routers (110) of the network, each network interface controller (108) inspects each packet for memory instructions. Each packet containing a memory instruction is handed to the memory communications controller (106) associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In the NOC (102) of FIG. 3, each IP block (104) is enabled to bypass its memory communications controller (106) and send inter-IP block, network-addressed communications (146) directly to the network through the IP block's network interface controller (108). Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through it I/O functions (124) directly to the IP block's network interface controller in command format, then converted to packet format by the network interface controller and transmitted through routers of the NOC to another IP block. Such network-addressed communications (146) are bi-directional, potentially proceeding to and from each IP block of the NOC, depending on their use in any particular application. Each network interface controller, however, is enabled to both send and receive (142) such communications to and from an associated router, and each network interface controller is enabled to both send and receive (146) such communications directly to and from an associated IP block, bypassing an associated memory communications controller (106).

Each network interface controller (108) in the example of FIG. 3 is also enabled to implement virtual channels on the network, characterizing network packets by type. Each network interface controller (108) includes virtual channel implementation logic (138) that classifies each communication instruction by type and records the type of instruction in a field of the network packet format before handing off the instruction in packet form to a router (110) for transmission on the NOC. Examples of communication instruction types include inter-IP block network-address-based messages, request messages, responses to request messages, invalidate messages directed to caches; memory load and store messages; and responses to memory load messages, and so on.

Each router (110) in the example of FIG. 3 includes routing logic (130), virtual channel control logic (132), and virtual channel buffers (134). The routing logic typically is implemented as a network of synchronous and asynchronous logic that implements a data communications protocol stack for data communication in the network formed by the routers (110), links (120), and bus wires among the routers. The routing logic (130) includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed. Each router in this example includes five ports, four ports (121) connected through bus wires (120-A, 120-B, 120-C, 120-D) to other routers and a fifth port (123) connecting each router to its associated IP block (104) through a network interface controller (108) and a memory communications controller (106).

In describing memory-address-based communications above, each memory address was described as mapped by network interface controllers to a network address, a network location of a memory communications controller. The network location of a memory communication controller (106) is naturally also the network location of that memory communication controller's associated router (110), network interface controller (108), and IP block (104). In inter-IP block, or network-address-based communications, therefore, it is also typical for application-level data processing to view network addresses as location of IP block within the network formed by the routers, links, and bus wires of the NOC. FIG. 6 illustrates that one organization of such a network is a mesh of rows and columns in which each network address can be implemented, for example, as either a unique identifier for each set of associated router, IP block, memory communications controller, and network interface controller of the mesh or x,y coordinates of each such set in the mesh.

In the NOC (102) of FIG. 3, each router (110) implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router (110) in the example of FIG. 3 also includes virtual channel control logic (132) and virtual channel buffers (134). The virtual channel control logic (132) examines each received packet for its assigned communications type and places each packet in an outgoing virtual channel buffer for that communications type for transmission through a port to a neighboring router on the NOC.

Each virtual channel buffer (134) has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer (134) in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller (108). Each network interface controller is configured to, upon receipt of such a signal, refuse to accept, from its associated memory communications controller (106) or from its associated IP block (104), communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped in the architecture of FIG. 3. When a router encounters a situation in which a packet might be dropped in some unreliable protocol such as, for example, the Internet Protocol, the routers in the example of FIG. 3 suspend by their virtual channel buffers (134) and their virtual channel control logic (132) all transmissions of packets in a virtual channel until buffer space is again available, eliminating any need to drop packets. The NOC of FIG. 3, therefore, implements highly reliable network communications protocols with an extremely thin layer of hardware.

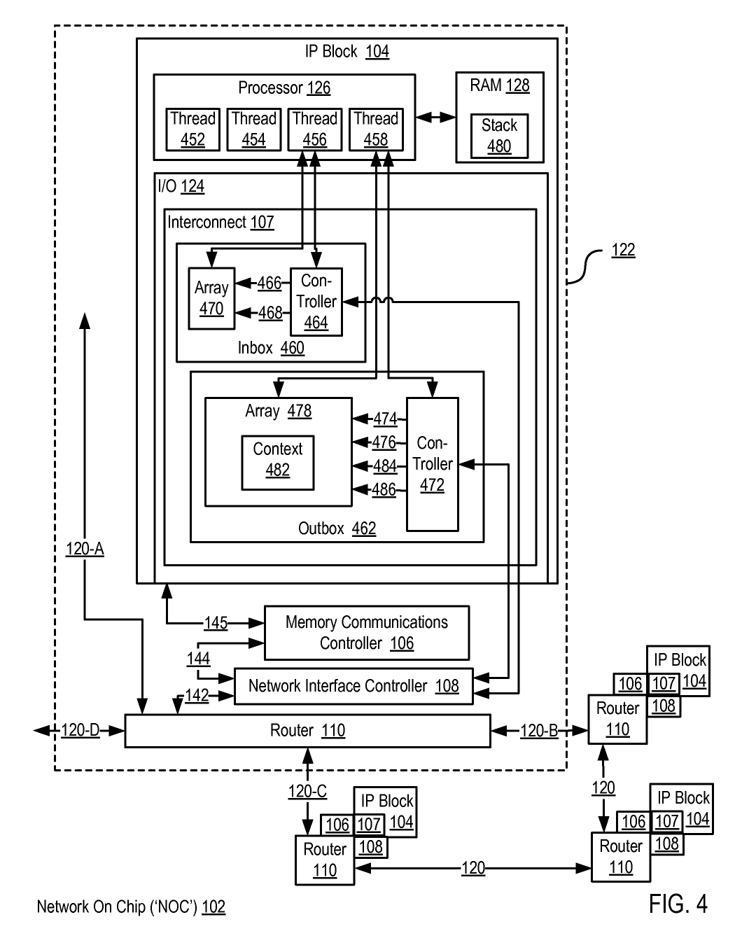

For further explanation, FIG. 4 sets forth a functional block diagram of a further example NOC according to embodiments of the present invention. The example NOC of FIG. 4 is similar to the example NOC of FIG. 6 in that the example NOC of FIG. 4 is implemented on a chip (100 on FIG. 6), and the NOC (102) of FIG. 4 includes integrated processor (‘IP’) blocks (104), routers (110), memory communications controllers (106), and network interface controllers (108). Each IP block (104) is adapted to a router (110) through a memory communications controller (106) and a network interface controller (108). Each memory communications controller controls communications between an IP block and memory, and each network interface controller (108) controls inter-IP block communications through routers (110).

In the example of FIG. 4, each IP block includes a low latency, high bandwidth application messaging interconnect (107) that adapts the IP block to the network for purposes of data communications among IP blocks. The low latency, high bandwidth application messaging interconnect (107) is an interconnect in the sense that it is composed of sequential and non-sequential logic that connects an IP block (104) to a network interface controller (108) for purposes of data communications. The low latency, high bandwidth application messaging interconnect (107) is a low latency, high bandwidth interconnect in that it provides a very fast interconnection between the IP block and the network interface controller—so fast because from the point of view of the IP block, for outgoing messages, the process of sending a message to the network interface controller represents a single immediate write to high speed local memory in the outbox array (478), and receiving a message in the IP block (104) from the network interface controller (108) represents a single read operation from a high speed local memory in the inbox array (470). As described in more detail below, each such messaging interconnect (107) includes an inbox (460) and an outbox (462). In the example of FIG. 4, one set (122) of an IP block (104) adapted to a router (110) through a memory communications controller (106) and network interface controller (108) is expanded to aid a more detailed explanation of the structure and operations of the messaging interconnect (107). All the IP blocks, memory communications controllers, network interface controllers, and routers in the example of FIG. 4 are configured in the same manner as the expanded set (122).

In the example NOC of FIG. 4, each outbox (462) includes an array (478) of memory indexed by an outbox write pointer (474) and an outbox read pointer (476). Each outbox (462) also includes an outbox message controller (472). In the example NOC of FIG. 4, the outbox has an associated thread of execution (458) that is a module of computer program instructions executing on a processor of the IP block. Each such associated thread of execution (458) is enabled to write message data into the array (478) and to provide to the outbox message controller (472) message control information, including message destination identification and an indication that message data in the array (478) is ready to be sent. The message control information, such as destination address or message identification, and other control information such as ‘ready to send,’ may be written to registers in the outbox message controller (472) or such information may be written into the array (478) itself as part of the message data, in a message header, message meta-data, or the like.

The outbox message controller (472) is implemented as a network of sequential and non-sequential logic that is enabled to set the outbox write pointer (474). The outbox write pointer (474) may be implemented, for example, as a register in the outbox message controller (472) that stores the memory address of the location in the array where the associated thread of execution is authorized to write message data. The outbox message controller (472) is also enabled to set the outbox read pointer (476). The outbox read pointer (476) may be implemented, for example, as a register in the outbox message controller (472) that stores the memory address of the location in the array where the outbox message controller is to read its next message data for transmission over the network from the outbox.

The outbox message controller (472) is also enabled to send to the network message data written into the array (478) by the thread of execution (458) associated with the outbox (462). In the NOC (102) of FIG. 4, each network interface controller (108) is enabled to convert communications instructions from command format to network packet format for transmission among the IP blocks (104) through routers (110). The communications instructions are formulated in command format by the associated thread of execution (458) in the IP block (104) and provided by the outbox message controller (472) to the network interface controller (108) in command format. The command format is a native format that conforms to architectural register files of the IP block (104) and the outbox message controller (472). The network packet format is the format required for transmission through routers (110) of the network. Each such message is composed of one or more network packets. Such communications instructions may include, for example, communications instructions that send messages among IP blocks carrying data and instructions for processing the data among IP blocks in parallel applications and in pipelined applications.

In the example NOC of FIG. 4, each inbox (460) includes an array (470) of memory indexed by an inbox write pointer (466) and an inbox read pointer (468). Each inbox (460) also includes an inbox message controller (464). The inbox message controller (454) is implemented as a network of sequential and non-sequential logic that is enabled to set the inbox write pointer (466). The inbox write pointer (466) may be implemented, for example, as a register in the inbox message controller (454) that stores the memory address of the beginning location in the array (470) where message data from an outbox of another IP block is to be written. The inbox message controller (454) is also enabled to set the inbox read pointer (468). The inbox read pointer (468) may be implemented, for example, as a register in the inbox message controller (454) that stores the memory address of the beginning location in the array (470) where an associated thread of execution (456) may read the next message received from an outbox of some other IP block.

In the example NOC of FIG. 4, the inbox has an associated thread of execution (456) that is a module of computer program instructions executing on a processor of the IP block. Each such associated thread of execution (456) is enabled to read from the array message data sent from some other outbox of another IP block. The thread of execution may be notified that message data sent from another outbox of another IP block has been written into the array by the message controller through a flag set in a status register, for example.

The inbox message controller (454) is also enabled to receive from the network message data written to the network from an outbox of another IP block and provide to a thread of execution (456) associated with the inbox (460) the message data received from the network. The inbox message controller of FIG. 4 receives from a network interface controller (108) message data from an outbox of some other IP block and writes the received message data to the array (470). Upon writing the received message data to the array, the inbox message controller (464) is also enabled to notify the thread of execution (456) associated with the inbox that message data has been received from the network by, for example, setting a data-ready flag in a status register of the inbox message controller (454). The associated thread of execution may, for example, ‘sleep until flag’ before a message load, or a load opcode can be configured to check a data-ready flag in the inbox message controller.

In addition, each IP block in the example of FIG. 4 also includes a stack (480) normally used for context switching, where the stack access is slower than the outbox access. Stack access is slower than outbox access because accessing the contents of memory in the stack is slower than accessing the contents of memory in the outbox arrray (478). The stack (480) is shown here as a segment of RAM (128) on an IP block, illustrating the fact that the stack is implemented as a segment of main memory, which in this architecture can be, not just on the same IP block, but anywhere in the NOC's hardware memory address space, physically associated with the subject IP block, some other IP block, this router or another router, on or off the NOC. Memory in the outbox array, however, is implemented as high speed, local, computer hardware memory—typically an order of magnitude faster than accessing a stack in main memory.

Each IP block in this example also includes a processor (126) supporting a plurality of threads of execution (452-458), where the processor is configured to save, upon a context switch, a context (482) of a current thread of execution in memory locations in a memory array (478) in the outbox (462) instead of the stack (480). The context for a thread of execution is the contents of one or more of the architectural registers currently used for program execution by the thread. Examples of such architectural registers includes, for example, an instruction pointer, status flag registers, one or more stack pointers, memory address indexing registers, one or more general purpose registers, and so on.

A context switch is the computing process of storing and restoring the context for a thread on a processor such that multiple threads of execution can share a single processor. The context switch is a typical feature of a multitasking NOC according to embodiments of the present invention. Context switches are computationally intensive and much of the design of a NOC according to embodiments of the present invention typically includes optimizing the use of context switches. A context switch among two or more threads of execution is typically implemented by storing the context of the thread presently in possession of a processor, replacing the stored context in the architectural registers of the processor with the previously-stored context of another thread (including the new thread's instruction pointer), and continuing at the point in program execution indicated by the new thread's instruction pointer value.

Each processor in an IP block in this example is also configure to lock the memory locations in which a context (482) is saved. In the NOC of FIG. 4, the outbox includes a base pointer (484) defining the beginning of an accessible portion of the array (478) and an offset pointer (486) defining the currently accessible portion of the array. In the NOC of FIG. 4, the processor locks the memory locations in which the context was saved by saving a last memory location of the context as the value of the base pointer (484) and setting the offset pointer (486) to zero. The processors in the NOC of FIG. 4 are also configured to unlock, upon returning from a context switch, the memory locations in which the context (482) was saved. The processors unlock the memory locations in which the context (482) was saved by saving a first memory location of the context as the value of the base pointer (484) and setting the offset pointer (486) to zero.

The processors in the NOC of FIG. 4 are also configured to restore, upon returning from the context switch, the context saved in memory locations in the array in the outbox. In the NOC of FIG. 4, the processor restores the context saved in memory locations in the array in the outbox by restoring the contents of the context to the architectural registers of the processor and moving a read pointer of the outbox past the saved context to a next message space. The outbox read pointer (476) in this example is a register in the outbox message controller (472) that stores the memory address of the location in the array (478) where the outbox message controller is to read its next message data for transmission over the network from the outbox. Moving the read pointer of the outbox past the saved context to a next message space is carried out by storing in the read pointer the memory address of the beginning of the next message storage location in the outbox array, thereby advising the outbox message controller to read its next message from the message storage location rather than the context space.

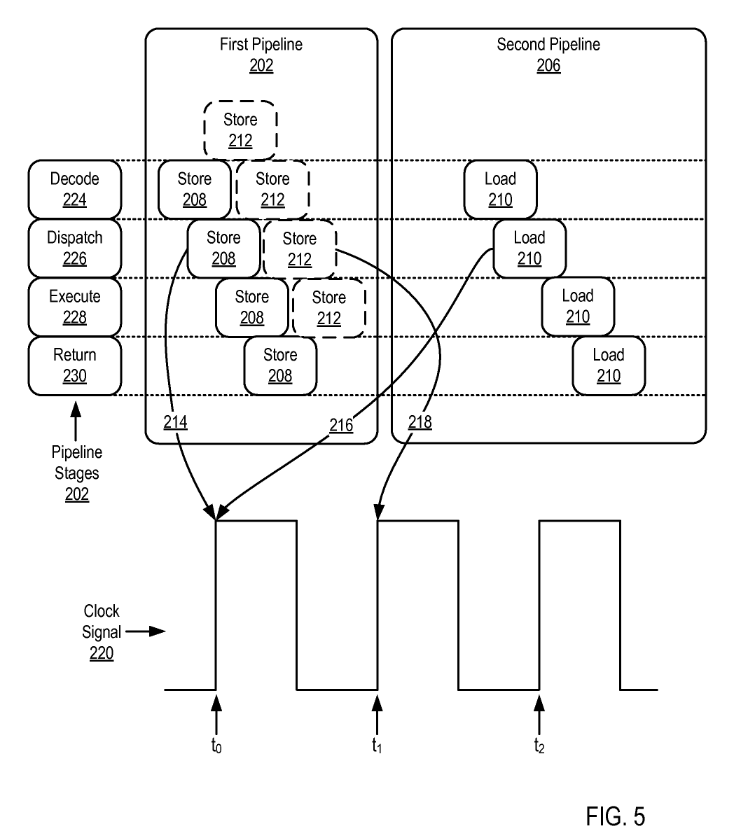

FIG. 5

A processor in a NOC according to embodiments of the present invention includes multiple execution units to allow the processing in multiple pipelines of more than one instruction at a time. A ‘pipeline,’ as the term is used here, is a hardware pipeline, a set of data processing elements connected in series within a processor, so that the output of one processing element is the input of the next one. Each element in such a series of elements is referred to as a ‘stage,’ so that pipelines are characterized by a particular number of stages, a three-stage pipeline, a four-stage pipeline, and so on. All pipelines have at least two stages, and some pipelines have more than a dozen stages. The processing elements that make up the stages of a pipeline are the logical circuits that implement the various stages of an instruction (address decoding and arithmetic, register fetching, cache lookup, and so on). Implementation of a pipeline allows a processor to operate more efficiently because a computer program instruction can execute simultaneously with other computer program instructions, one in each stage of the pipeline at the same time. Thus a five-stage pipeline can have five computer program instructions executing in the pipeline at the same time, one being fetched from a register, one being decoded, one in execution in an execution unit, one retrieving additional required data from memory, and one having its results written back to a register, all at the same time on the same clock cycle.

For further explanation of such hardware pipelines, FIG. 5 sets forth an exemplary timing diagram that illustrates pipeline operations in a processor of an IP block on a NOC according to embodiments of the present invention. The timing diagram of FIG. 5 illustrates a first store microinstruction (208) as it progresses through the pipeline stages (202) of a first pipeline (204). The timing diagram of FIG. 5 also illustrates a corresponding load microinstruction (210) as it progresses through the pipeline stages of a second pipeline (206). The timing diagram of FIG. 5 also illustrates a second store microinstruction (212) as it progresses through the pipeline stages of the first pipeline (204) just behind the first store microinstruction (208). Although processor design does not necessarily require that each pipeline stage be executed in one processor clock cycle, it is assumed here for ease of explanation, that each of the pipeline stages in the example of FIG. 5 requires one clock cycle to complete the stage. The first store microinstruction and the corresponding load microinstruction enter the pipeline simultaneously, on the same clock cycle. They are both decoded (224) on the same clock cycle, and they are both dispatched (226) to execution units on the same clock cycle. They both enter the execution stage (228) on the same clock cycle, both executing (214, 216) on the same clock cycle at to. The execution engine executes (218) the second store microinstruction (212) immediately after executing the first store microinstruction (208). The store microinstructions (208, 212) are dispatched for execution on the immediately consecutive clock cycles, t₀ and t₁ , and the store microinstructions execute on the immediately consecutive clock cycles, t₀ and t₁.

An additional aid to speed in accessing memory in the outbox array is the fact that the memory locations in the outbox where a context is saved may be pipelined to a store execution unit in a processor in the IP block. For further explanation, FIG. 6 sets forth a functional block diagram of exemplary apparatus for data processing on a NOC according to embodiments of the present invention, including a computer processor (126), an outbox (462), and a network interface controller (108) of the kinds described in detail above. The processor (126) in this example includes a register file (326) made up of all the registers (328) of the processor. The register file (326) is an array of processor registers implemented, for example, with fast static memory devices. The registers include registers (320) that are accessible only by the execution units as well as ‘architectural registers’ (318). The instruction set architecture of processor (126) defines a set of registers, called ‘architectural registers,’ that are used to stage data between memory and the execution units in the processor. The architectural registers are the registers that are accessible directly by user-level computer program instructions.

The processor (126) includes a decode engine (322), a dispatch engine (324), an execution engine (340), and a writeback engine (355). Each of these engines is a network of static and dynamic logic within the processor (126) that carries out particular functions for pipelining program instructions internally within the processor. The decode engine (322) retrieves machine code instructions from registers in the register set and decodes the machine instructions into microinstructions. The dispatch engine (324) dispatches microinstructions to execution units in the execution engine. Execution units in the execution engine (340) execute microinstructions. And the writeback engine (355) writes the results of execution back into the correct registers in the register file (326).

The processor (126) includes a decode engine (322) that reads a user-level computer program instruction and decodes that instruction into one or more microinstructions for insertion into a microinstruction queue (310). Just as a single high level language instruction is compiled and assembled to a series of machine instructions (load, store, shift, etc), each machine instruction is in turn implemented by a series of microinstructions. Such a series of microinstructions is sometimes called a ‘microprogram’ or ‘microcode.’ The microinstructions are sometimes referred to as ‘micro-operations,’ ‘micro-ops,’ or ‘μops’—although in this specification, a microinstruction is usually referred to as a ‘microinstruction.’

Microprograms are carefully designed and optimized for the fastest possible execution, since a slow microprogram would yield a slow machine instruction which would in turn cause all programs using that instruction to be slow. Microinstructions, for example, may specify such fundamental operations as the following:
Connect Register 1 to the “A” side of the ALU
Connect Register 7 to the “B” side of the ALU
Set the ALU to perform two's-complement addition
Set the ALU's carry input to zero
Store the result value in Register 8
Update the “condition codes” with the ALU status flags (“Negative”, “Zero”, “Overflow”, and “Carry”)
Microjump to MicroPC nnn for the next microinstruction

For a further example: A typical assembly language instruction to add two numbers, such as, for example, ADD A, B, C, may add the values found in memory locations A and B and then put the result in memory location C. In processor (126), the decode engine (322) may break this user-level instruction into a series of microinstructions similar to:

LOAD A, Reg1
LOAD B, Reg2
ADD Reg1, Reg2, Reg3
STORE Reg3, C

It is these microinstructions that are then placed in the microinstruction queue (310) to be dispatched to execution units.

Processor (126) also includes a dispatch engine (324) that carries out the work of dispatching individual microinstructions from the microinstruction queue to execution units. The processor (126) includes an execution engine that in turn includes several execution units, two load memory instruction execution units (330, 300), two store memory instruction execution units (332, 302), two ALUs (334, 336), and a floating point execution unit (338). The microinstruction queue in this example includes a first store microinstruction (312), a corresponding load microinstruction (314), and a second store microinstruction (316). The load instruction (314) is said to correspond to the first store instruction (312) because the dispatch engine (324) dispatches both the first store instruction (312) and its corresponding load instruction (314) into the execution engine (340) at the same time, on the same clock cycle. The dispatch engine can do so because the execution engine support two or more pipelines of execution, so that two or more microinstructions can move through the execution portion of the pipelines at exactly the same time.

The memory locations in the outbox (462) where a context (482) is saved in this example are pipelined to a store execution unit (302) in the processor in that the store execution unit has a direct connection (305), a memory bus or the like, between the store execution unit and the high speed memory array (478) in the outbox (462) where a context is saved. The term ‘pipelined’ here denotes the direct connection between the store execution unit (302), an element of a hardware pipeline, and the high speed memory array (478) in the outbox (462). Access by the store execution unit to such a memory locations in such a pipelined memory array is advantageoulsy very fast. To explain the speed advantage, consider the contrasting example of context storage on a stack (480 on FIG. 4) implemented in main memory of a NOC. If the processors on the IP blocks on the NOC operate in virtual memory space, the contrast is even more dramatic. Access between a store execution unit and such a stack would risk a cache miss, a memory fault, and a hard disk access on every store microinstruction.

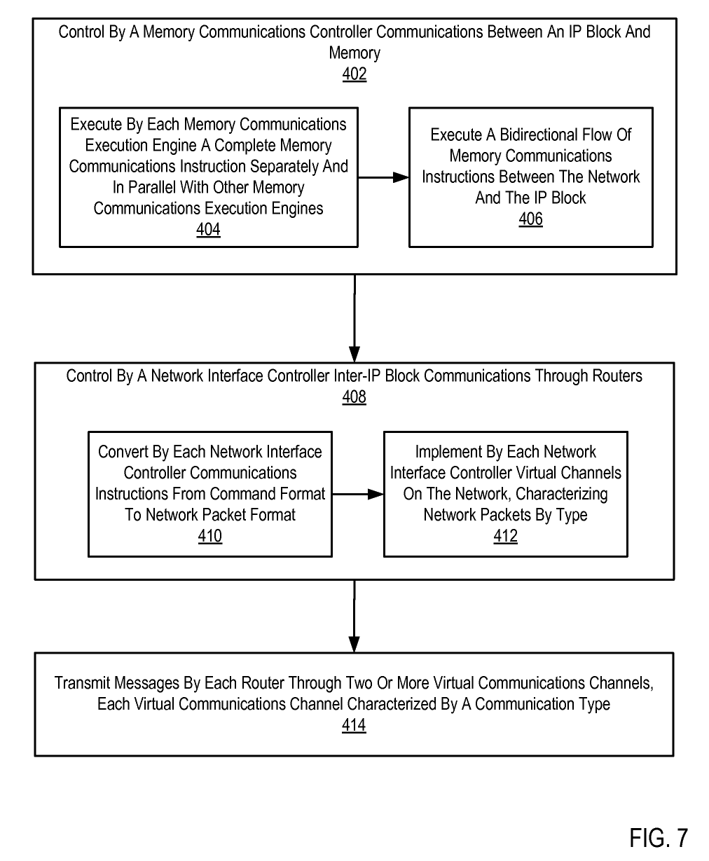

For further explanation, FIG. 7 sets forth a flow chart illustrating an exemplary method for data processing with a NOC according to embodiments of the present invention. The method of FIG. 7 is implemented on a NOC similar to the ones described above in this specification, a NOC (102 on FIG. 3) that is implemented on a chip (100 on FIG. 3) with IP blocks (104 on FIG. 3), routers (110 on FIG. 3), memory communications controllers (106 on FIG. 3), and network interface controllers (108 on FIG. 3). Each IP block (104 on FIG. 3) is adapted to a router (110 on FIG. 3) through a memory communications controller (106 on FIG. 3) and a network interface controller (108 on FIG. 3). In the method of FIG. 7, each IP block may be implemented as a reusable unit of synchronous or asynchronous logic design used as a building block for data processing within the NOC.

The method of FIG. 7 includes controlling (402) by a memory communications controller (106 on FIG. 3) communications between an IP block and memory. In the method of FIG. 7, the memory communications controller includes a plurality of memory communications execution engines (140 on FIG. 3). Also in the method of FIG. 7, controlling (402) communications between an IP block and memory is carried out by executing (404) by each memory communications execution engine a complete memory communications instruction separately and in parallel with other memory communications execution engines and executing (406) a bidirectional flow of memory communications instructions between the network and the IP block. In the method of FIG. 7, memory communications instructions may include translation lookaside buffer control instructions, cache control instructions, barrier instructions, memory load instructions, and memory store instructions. In the method of FIG. 7, memory may include off-chip main RAM, memory connected directly to an IP block through a memory communications controller, on-chip memory enabled as an IP block, and on-chip caches.

The method of FIG. 7 also includes controlling (408) by a network interface controller (108 on FIG. 3) inter-IP block communications through routers. In the method of FIG. 7, controlling (408) inter-IP block communications also includes converting (410) by each network interface controller communications instructions from command format to network packet format and implementing (412) by each network interface controller virtual channels on the network, including characterizing network packets by type.

The method of FIG. 7 also includes transmitting (414) messages by each router (110 on FIG. 3) through two or more virtual communications channels, where each virtual communications channel is characterized by a communication type. Communication instruction types, and therefore virtual channel types, include, for example: inter-IP block network-address-based messages, request messages, responses to request messages, invalidate messages directed to caches; memory load and store messages; and responses to memory load messages, and so on. In support of virtual channels, each router also includes virtual channel control logic (132 on FIG. 3) and virtual channel buffers (134 on FIG. 3). The virtual channel control logic examines each received packet for its assigned communications type and places each packet in an outgoing virtual channel buffer for that communications type for transmission through a port to a neighboring router on the NOC.

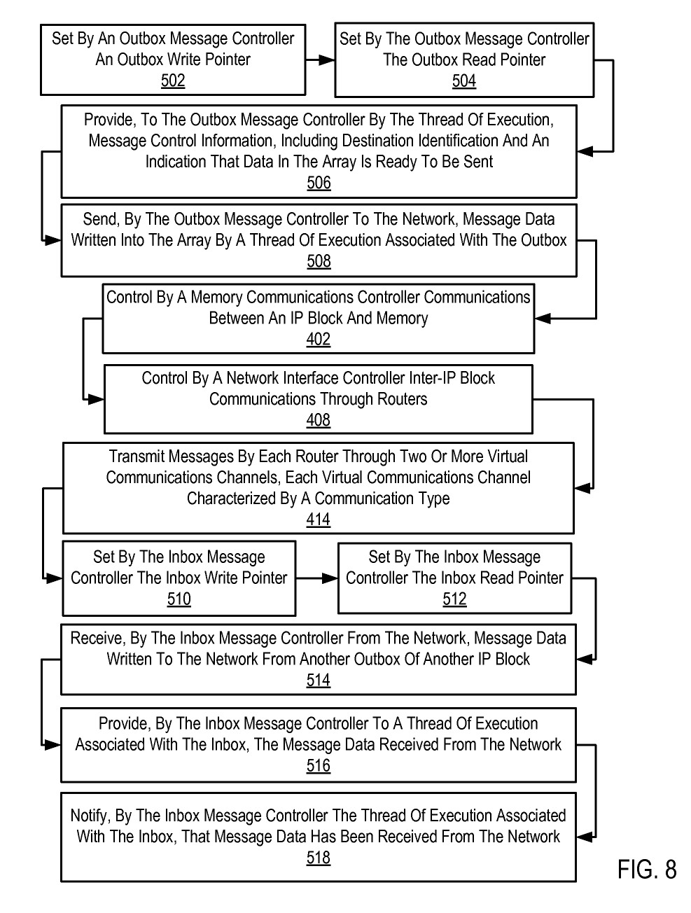

For further explanation, FIG. 8 sets forth a flow chart illustrating a further exemplary method for data processing with a NOC according to embodiments of the present invention. The method of FIG. 8 is similar to the method of FIG. 7 in that the method of FIG. 8 is implemented on a NOC similar to the ones described above in this specification, a NOC (102 on FIG. 3) that is implemented on a chip (100 on FIG. 3) with IP blocks (104 on FIG. 3), routers (110 on FIG. 3), memory communications controllers (106 on FIG. 3), and network interface controllers (108 on FIG. 3). Each IP block (104 on FIG. 3) is adapted to a router (110 on FIG. 3) through a memory communications controller (106 on FIG. 3) and a network interface controller (108 on FIG. 3).

In the method of FIG. 8, each IP block (104 on FIG. 3) may be implemented as a reusable unit of synchronous or asynchronous logic design used as a building block for data processing within the NOC, and each IP block is also adapted to the network by a low latency, high bandwidth application messaging interconnect (107 on FIG. 4) comprising an inbox (460 on FIG. 4) and an outbox (462 on FIG. 4). In the method of FIG. 8, each outbox (462 on FIG. 4) includes an outbox message controller (472 on FIG. 4) and an array (478 on FIG. 4) for storing message data, with the array indexed by an outbox write pointer (474 on FIG. 4) and an outbox read pointer (476 on FIG. 4). In the method of FIG. 8, each inbox (460 on FIG. 4) includes an inbox message controller (464 on FIG. 4) and an array (470 on FIG. 4) for storing message data, with the array (470 on FIG. 4) indexed by an inbox write pointer (466 on FIG. 4) and an inbox read pointer (468 on FIG. 4).

The method of FIG. 8, like the method of FIG. 7, method the following methos steps which operate in a similar manner as described above with regard to the method of FIG. 7: controlling (402) by each memory communications controller communications between an IP block and memory, controlling (408) by each network interface controller inter-IP block communications through routers, and transmitting (414) messages by each router (110 on FIG. 3) through two or more virtual communications channels, where each virtual communications channel is characterized by a communication type.

In addition to its similarities to the method of FIG. 7, however, the method of FIG. 8 also includes setting (502) by the outbox message controller the outbox write pointer. The outbox write pointer (474 on FIG. 4) may be implemented, for example, as a register in the outbox message controller (472 on FIG. 4) that stores the memory address of the location in the array where the associated thread of execution is authorized to write message data.

The method of FIG. 8 also includes setting (504) by the outbox message controller the outbox read pointer. The outbox read pointer (476 on FIG. 4) may be implemented, for example, as a register in the outbox message controller (472 on FIG. 4) that stores the memory address of the location in the array where the outbox message controller is to read its next message data for transmission over the network from the outbox.

The method of FIG. 8 also includes providing (506), to the outbox message controller by the thread of execution, message control information, including destination identification and an indication that data in the array is ready to be sent. The message control information, such as destination address or message identification, and other control information such as ‘ready to send,’ may be written to registers in the outbox message controller (472 on FIG. 4) or such information may be written into the array (478 on FIG. 4) itself as part of the message data, in a message header, message meta-data, or the like.

The method of FIG. 8 also includes sending (508), by the outbox message controller to the network, message data written into the array by a thread of execution associated with the outbox. In the NOC upon which the method of FIG. 8 is implemented, each network interface controller (108 on FIG. 4) is enabled to convert communications instructions from command format to network packet format for transmission among the IP blocks (104 on FIG. 4) through routers (110 on FIG. 4). The communications instructions are formulated in command format by the associated thread of execution (458 on FIG. 4) in the IP block (104 on FIG. 4) and provided by the outbox message controller (472 on FIG. 4) to the network interface controller (108 on FIG. 4) in command format. The command format is a native format that conforms to architectural register files of the IP block (104 on FIG. 4) and the outbox message controller (472 on FIG. 4). The network packet format is the format required for transmission through routers (110 on FIG. 4) of the network. Each such message is composed of one or more network packets. Such communications instructions may include, for example, communications instructions that send messages among IP blocks carrying data and instructions for processing the data among IP blocks in parallel applications and in pipelined applications.

The method of FIG. 8 also includes setting (510) by the inbox message controller the inbox write pointer. The inbox write pointer (466 on FIG. 4) may be implemented, for example, as a register in the inbox message controller (454 on FIG. 4) that stores the memory address of the beginning location in the array (470 on FIG. 4) where message data from an outbox of another IP block is to be written.

The method of FIG. 8 also includes setting (512) by the inbox message controller the inbox read pointer. The inbox read pointer (468 on FIG. 4) may be implemented, for example, as a register in the inbox message controller (454 on FIG. 4) that stores the memory address of the beginning location in the array (470 on FIG. 4) where an associated thread of execution (456 on FIG. 4) may read the next message received from an outbox of some other IP block.

The method of FIG. 8 also includes receiving (514), by the inbox message controller from the network, message data written to the network from another outbox of another IP block, and providing (516), by the inbox message controller to a thread of execution associated with the inbox, the message data received from the network. The inbox message controller (454 on FIG. 4) is enabled to receive from the network message data written to the network from an outbox of another IP block and provide to a thread of execution (456 on FIG. 4) associated with the inbox (460 on FIG. 4) the message data received from the network. The inbox message controller of FIG. 4 receives from a network interface controller (108 on FIG. 4) message data from an outbox of some other IP block and writes the received message data to the array (470 on FIG. 4).

The method of FIG. 8 also includes notifying (518), by the inbox message controller the thread of execution associated with the inbox, that message data has been received from the network. Upon writing the received message data to the array, an inbox message controller (464 on FIG. 4) is also enabled to notify the thread of execution (456 on FIG. 4) associated with the inbox that message data has been received from the network by, for example, setting a data-ready flag in a status register of the inbox message controller (454 on FIG. 4). The associated thread of execution may, for example, ‘sleep until flag’ before a message load, or a load opcode can be configured to check a data-ready flag in the inbox message controller.

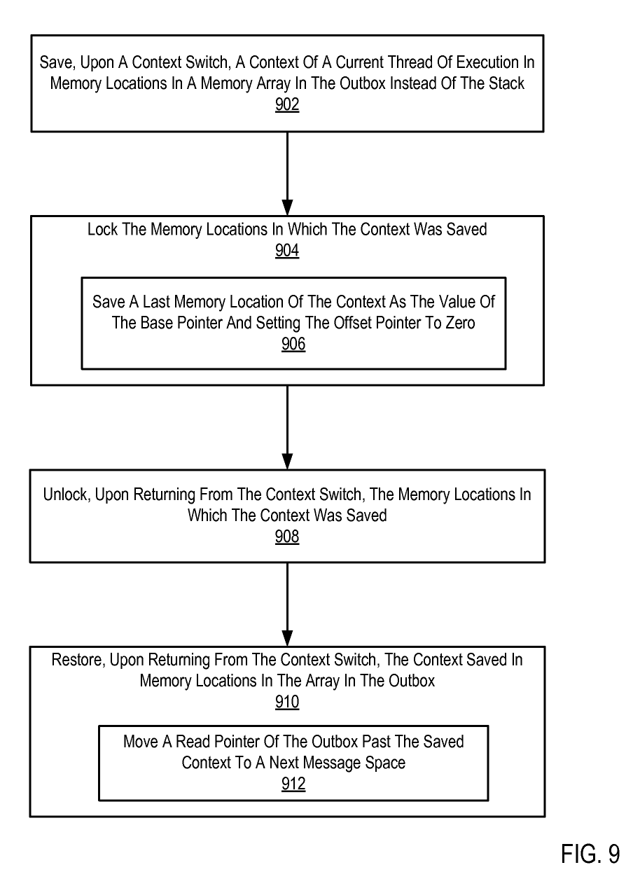

For further explanation, FIG. 9 sets forth a flow chart illustrating a further exemplary method for data processing with a NOC according to embodiments of the present invention. The method of FIG. 9 is implemented on a NOC similar to the ones described above in this specification, a NOC (102 on FIG. 3) that is implemented on a chip (100 on FIG. 3) with IP blocks (104 on FIG. 3), routers (110 on FIG. 3), memory communications controllers (106 on FIG. 3), and network interface controllers (108 on FIG. 3). Each IP block (104 on FIG. 3) is adapted to a router (110 on FIG. 3) through a memory communications controller (106 on FIG. 3) and a network interface controller (108 on FIG. 3). On a NOC on which the method of FIG. 9 is implemented, each IP block is further adapted to the network by a low latency, high bandwidth application messaging interconnect (107 on FIG. 4) comprising an inbox (460 on FIG. 4) and an outbox (462 on FIG. 4), each IP block also includes a stack (480 on FIG. 4) normally used for context switching, where the stack access is slower than the outbox access, and each IP block also includes a processor (126) supporting a plurality of threads (452-458) of execution.

The method of FIG. 9 includes saving (902), upon a context switch, a context of a current thread of execution in memory locations in a memory array in the outbox instead of the stack. In the method of FIG. 9, the stack may be implemented as a segment of main memory, and the memory locations in the outbox may be pipelined to a store execution unit in the IP block.

The method of FIG. 9 also includes locking (904) the memory locations in which the context was saved. In the method of FIG. 9, the outbox may include a base pointer defining the beginning of an accessible portion of the memory array and an offset pointer defining the currently accessible portion of the array. Locking (904) the memory locations in which the context was saved may be carried out by saving (906) a last memory location of the context as the value of the base pointer and setting the offset pointer to zero.

The method of FIG. 9 also includes unlocking (908), upon returning from the context switch, the memory locations in which the context was saved and restoring (910), upon returning from the context switch, the context saved in memory locations in the array in the outbox. In the method of FIG. 9, restoring (910) the context saved in memory locations in the array in the outbox includes moving (912) a read pointer of the outbox past the saved context to a next message space.

Exemplary embodiments of the present invention are described largely in the context of a fully functional computer system for data processing on a NOC. Readers of skill in the art will recognize, however, that the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A network on chip (‘NOC’) comprising:
IP blocks, routers, memory communications controllers, and network interface controller, each IP block adapted to a router through a memory communications controller and a network interface controller, each memory communications controller controlling communication between an IP block and memory, each network interface controller controlling inter-IP block communications through routers,
each IP block further adapted to the network by a low latency, high bandwidth application messaging interconnect comprising an inbox and an outbox, each IP block also including a stack normally used for context switching, the stack access slower than the outbox access,
each IP block further comprising a processor supporting a plurality of threads of execution, the processor configured to save, upon a context switch, a context of a current thread of execution in memory locations in a memory array in the outbox instead of the stack and lock the memory locations in which the context was saved.

2. The NOC of claim 1 wherein:
the stack comprises a segment of main memory, and
the memory locations in the outbox are pipelined to a store execution unit in the IP block.

3. The NOC of claim 1 wherein:
the outbox further comprises a base pointer defining the beginning of an accessible portion of the array and an offset pointer defining the currently accessible portion of the array; and
processor configured to lock the memory locations in which the context was saved further comprises processor configured to save a last memory location of the context as the value of the base pointer and setting the offset pointer to zero.

4. The NOC of claim 1 further comprising the processor configured to:
unlock, upon returning from the context switch, the memory locations in which the context was saved; and
restore, upon returning from the context switch, the context saved in memory locations in the array in the outbox.

5. The method of claim 4 wherein the processor configured to restore the context saved in memory locations in the array in the outbox further comprises the processor configured to move a read pointer of the outbox past the saved context to a next message space.

6. The NOC of claim 1 wherein the memory communications controller comprises:
a plurality of memory communications execution engines, each memory communications execution engine enabled to execute a complete memory communications instruction separately and in parallel with other memory communications execution engines; and
bidirectional memory communications instruction flow between the network and the IP block.

7. The NoC of claim 1 wherein each IP block comprises a reusable unit of synchronous or asynchronous logic design used as a building block for data processing within the NOC.

8. The NoC of claim 1 wherein each router comprises
two or more virtual communications channels, each virtual communications channel characterized by a communication type.

9. The NoC of claim 1 wherein each network interface controller is enabled to:
convert communications instructions from command format to network packet format; and
implement virtual channels on the network, characterizing network packets by type.

10. A method of data processing on a network on chip (‘NOC’), the NOC comprising: IP blocks, routers, memory communications controllers, and network interface controller, each IP block adapted to a router through a memory communications controller and a network interface controller, each memory communications controller controlling communication between an IP block and memory, each network interface controller controlling inter-IP block communications through routers, each IP block further adapted to the network by a low latency, high bandwidth application messaging interconnect comprising an inbox and an outbox, each IP block also including a stack normally used for context switching, the stack access slower than the outbox access, each IP block further comprising a processor supporting a plurality of threads of execution, the method comprising:
saving, upon a context switch, a context of a current thread of execution in memory locations in a memory array in the outbox instead of the stack; and
locking the memory locations in which the context was saved.

11. The method of claim 10 wherein:
the stack comprises a segment of main memory, and
the memory locations in the outbox are pipelined to a store execution unit in the IP block.

12. The method of claim 10 wherein:
the outbox further comprises a base pointer defining the beginning of an accessible portion of the array and an offset pointer defining the currently accessible portion of the array; and
locking the memory locations in which the context was saved further comprises saving a last memory location of the context as the value of the base pointer and setting the offset pointer to zero.

13. The method of claim 10 further comprising:
unlocking, upon returning from the context switch, the memory locations in which the context was saved; and
restoring, upon returning from the context switch, the context saved in memory locations in the array in the outbox.

14. The method of claim 13 wherein restoring the context saved in memory locations in the array in the outbox further comprises moving a read pointer of the outbox past the saved context to a next message space.

15. The method of claim 10 wherein the memory communications controller comprises a plurality of memory communications execution engines and the method further comprises controlling communications between an IP block and memory, including:
executing by each memory communications execution engine a complete memory communications instruction separately and in parallel with other memory communications execution engines; and
executing a bidirectional flow of memory communications instructions between the network and the IP block.

16. The method of claim 10 wherein each IP block comprises a reusable unit of synchronous or asynchronous logic design used as a building block for data processing within the NOC.

17. The method of claim 10 further comprising transmitting messages by each router through two or more virtual communications channels, each virtual communications channel characterized by a communication type.

18. The method of claim 10 further comprising controlling inter-IP block communications, including:
converting by each network interface controller communications instructions from command format to network packet format; and
implementing by each network interface controller virtual channels on the network, characterizing network packets by type.
